(19) United States
(12) Patent Application Publication
(10) Pub. No.: US 2013/0051996 A1
(43) Pub. Date: Feb. 28, 2013

(54) TRANSITION CHANNEL OF A TURBINE UNIT

(71) Applicants: MARTIN HOEGER, Erding (DE); KAI KOERBER, Karlsfeld (DE); KARL ENGEL, Dachau (DE)

(72) Inventors: MARTIN HOEGER, Erding (DE); KAI KOERBER, Karlsfeld (DE); KARL ENGEL, Dachau (DE)

(73) Assignee: MTU AERO ENGINES GMBH, Munchen (DE)

(21) Appl. No.: 13/597,440

(22) Filed: Aug. 29, 2012

(30) Foreign Application Priority Data
Aug. 29, 2011 (DE) 102011115499.3

(51) Int. Cl. F01D 1/02; F02C 3/00

(52) U.S. Cl. 415/185

(57) ABSTRACT

A transition channel for a turbine unit with at least two components is configured as a flow channel from one component of a first pressure to a component of a second pressure. The transition channel has support ribs, extending between envelope surfaces of the transition channel and having a profile that is configured for the deflecting of a flow from an inlet cross section to an outlet cross section of the transition channel. Flow splitter blades are arranged between the support ribs, having a smaller relative profile thickness than the support ribs and/or a shorter axial design depth or profile chord length than the support ribs. Thanks to the integration of the slim and/or short flow splitter blades (tandem blades), it is possible to largely dissipate parasite secondary flows.

### CROSS-REFERENCE TO RELATED APPLICATIONS

This application claims benefit of German Patent Application No. 102011115499.3, filed Aug. 29, 2011, entitled ÜBERGANGSKANAL EINE TURBOAGGREGATS, the specification of which is incorporated herein in its entirety.

### TECHNICAL FIELD

The invention concerns a transition channel between components of a turbine unit, as well as a turbine unit and a jet engine, especially an aircraft engine, with such a transition channel.

### BACKGROUND

A transition channel, such as can be arranged in particular between a high-pressure turbine and a low-pressure turbine or—when the turbine has a three-piece design—between high and medium-pressure turbine and/or medium and low-pressure turbine, determines the flow to the first rotor of the downstream turbine. The transition or diversion channel (“turning mid turbine frame”, TMTF) generally guides the flow in annular or envelope fashion from an upstream flow cross section to a downstream flow cross section that has a rather large radial distance from the turbine axis. Also in multistage compressors, the transition channel directs the flow in similar fashion from an upstream to a downstream flow cross section.

For greater rigidity, such a transition channel generally has identical support ribs distributed about the periphery, which also bring about a diversion of the flow, especially in the circumferential or peripheral direction, in order to provide a flow to the blades of a first rotor of the downstream turbine or compressor stage.

These support ribs generally have a large relative thickness, i.e., a ratio of profile thickness to chord length, and/or a small blade height ratio, i.e., a ratio of blade height to chord length. The comparatively large relative thickness or small relative height of the support ribs can be required in particular for static strength.

Such a geometry of the support ribs, however, leads to intense secondary flows. Marginal areas are formed with an eddy flow, which can dominate the flow pattern. Such strong three-dimensional secondary flows are detrimental to the main flow; in particular, they may limit the maximum possible deflection at hub and housing and lead to energy transfer losses and excitation of the first rotor blade series of the downstream turbine, which can result in particular in higher noise levels for the turbine. Furthermore, the much smaller numbers of blades as compared to conventional stator geometry can result in aerodynamic excitation of the following rotor blades with fundamental modes, so-called “engine orders”, in the working range of the turbine unit.

A gas turbine with an annular transition channel from a high-pressure turbine section to a low-pressure turbine section is known from US 2010/0040462 A1, wherein the transition channel has guide vanes that extend between an outer envelope surface and an inner envelope surface of the transition channel and are distributed over the circumferential direction. The guide vanes have a wing profile. To minimize a “rolloff” of the flow in the transition from a horizontal to a radially ascending flow, the inner envelope surface has a particular curved shape.

A need therefore exists, for improved flow in a transition channel of this kind

### SUMMARY AND DESCRIPTION

The problem is solved according to the invention by a transition channel with the features as described and claimed herein, a turbine unit with the features as described and claimed herein and an engine with the features as described and claimed herein. Advantageous configurations and modifications of the invention are indicated in the particular subclaims.

The invention is based on the knowledge that eddies, flow losses and/or deflection constrictions can be reduced if additional deflection elements are arranged between the support ribs, which are likewise profiled for deflection of the flow, that are configured as narrower and/or shorter flow dividers as compared to the support ribs.

Accordingly, the present invention proposes a transition channel for a turbine unit, especially a gas turbine unit, with at least two components, wherein the transition channel is designed and oriented as a flow channel, especially a stationary one, from one component of a first pressure to a component of second pressure. The transition channel can have, in particular, an annular cross section and/or one whose axial shape is distant on the whole from one axis of the turbine unit.

The first pressure can be a higher one and the second pressure a lower one, if the transition channel is arranged between two turbines or turbine stages. Likewise, on the contrary, the first pressure can be a lower one and the second pressure a higher one, if the transition channel is arranged between two compressors or compressor stages, which can be components of a turbine unit in the sense of the present invention, such as turbines or turbine stages.

Support ribs extending between envelope surfaces of the transition channel have a profile that is designed and oriented for the axial, radial and/or circumferential deflecting of a flow from an inlet cross section to an outlet cross section of the transition channel.

One or more flow splitter blades are arranged between at least two, and preferably between all support ribs; preferably the same number of flow splitter blades are arranged between all support ribs and/or the flow splitter blades are spaced equidistant from each other and/or the support ribs.

From a first perspective of the invention, one or more and especially all of these flow splitter blades have a smaller relative profile thickness than the support ribs. By a relative profile thickness is meant, in particular, the quotient of the maximum or average profile thickness to the profile chord length.

Thanks to the integration of such slimmer flow splitter blades as tandem blades, it is possible to reduce parasite secondary flows, since now the slimmer tandem blades take over part of the deflection work.

It is proven to be especially advantageous for a relative profile thickness of the flow splitter blades to be at most 15%, preferably at most 10%.

Moreover, it has proven to be advantageous for the flow splitter blades to be arranged in a rear region of the support ribs, looking in the axial direction. In particular, it has proven to be advantageous for the front edges of some or all of the flow splitter blades, looking in the axial direction, to be distant by at least 25%, preferably at least 30%, of an axial design depth of the support ribs, from the furthermost front edge of the support ribs. According to the experience of the inventor, the flow splitter blades can fulfill their task especially well if an axial design depth of the flow splitter blades is less than an axial design depth of the support ribs; but the axial design depth of the flow splitter blades should be at least 30% of the axial design depth of the support ribs.

The support ribs can already achieve a substantial deflection of the flow and an increasing of the flow velocity in the region of the front 50% of the axial design depth of the long support ribs, likewise acting as deflection blades. If, now, one integrates a tandem blade in the rear region of the design depth of the support ribs in the design of a slender, preferably short flow splitter blade or vane, even higher velocities or Mach numbers can be handled with no problem upstream from the tandem blades.

Furthermore, it has proven to be especially advantageous for rear edges of the flow splitter blades to project beyond rear edges of the support ribs, looking in the axial direction, this projection in the axial direction being preferably at most 25% of an axial design depth of the support ribs. Thanks to such a design, the effective length of the flow deflection can be increased. Optionally, the flow deflection zone can also be extended to just prior to the first rotating blade series of the downstream component.

An advantageous flow deflection can often be accomplished already by arranging precisely one flow splitter blade between two support ribs. However, it is also possible to arrange two or more flow splitter blades between every two support ribs. Thanks to the deflection at the transition channel, the off-design requirements on the flow splitter blades are relatively slight, since the bulk of the unwanted flow is captured already by the long support ribs. The number of flow splitter blades is limited essentially by the maximum allowable partitioning of the transition channel for adequate off-design capability. Thus, the maximum allowable partitioning depends on the boundary conditions.

Most of the application cases will be covered if one to five flow splitter blades are arranged between the support ribs. Preferably, the total number of support ribs and flow splitter blades taken together is chosen such that excitations of fundamental modes of the rotor blades in the operating range by perturbation harmonics of the transition channel are prevented or reduced.

The present invention enables an improvement of the flow thanks to a partial division of functions: the number, shape and arrangement of the long and heavy support ribs is dictated by the supporting and the initial upstream flow deflection, as well as any supply lines to be accommodated in the support ribs, while the slender flow splitter blades take over the largest possible portion of the downstream flow deflection. Thus, short, light and highly efficient designs with rather high deflection become possible. The nonuniformity of the flow against the downstream component, the engine noise, and the exciting of the later rotor blades in the critical frequency range are reduced and the lifetime of the blading is increased.

It should be pointed out that the flow splitter blades, as well as the support ribs, preferably have a two or three-dimensional curved wing profile. Wing profiles have proven themselves in general and especially in the present application as effective profile shapes for deflection of flows.

From another perspective of the present invention, an axial design depth or a profile chord length of the flow splitter blades is shorter than an axial design depth or profile chord length of the support ribs. Thanks to the integration of the short flow splitter blades, which correspondingly have a larger blade height ratio, it is possible to largely dissipate parasite secondary flows, since now the shorter tandem blades take over some of the deflection task. This perspective can be combined with the above described perspective of the invention and its modifications.

According to another perspective of the present invention, a turbine unit is proposed, especially a gas turbine unit, with a first component and a second component, wherein the first component is associated with a different, especially a higher pressure than the second component, wherein one exit cross section of the first component has a smaller radial dimension than an entry cross section of the second component, wherein a transition channel is provided as a stationary flow channel between the first and the second component, and wherein the transition channel is configured according to one of the above described embodiments. It is especially advantageous in a two-piece construction of the turbine unit for the first component to be a high-pressure turbine and in a three-piece construction of the turbine unit for the first component to be a high or medium-pressure turbine, and the second component to be a low-pressure turbine, or optionally a medium-pressure turbine in a three-piece construction. Likewise, the first and second component of a turbine unit according to the invention can also be a compressor or a compressor stage, in which case the first component is associated with a lower pressure than the second component, and one exit cross section of the first component can have a larger radial dimension than an entry cross section of the second component.

According to another perspective of the invention, a jet engine is proposed, especially an aircraft engine, which is outfitted with a turbine unit as described above.

Embodiments of the present invention can reduce losses of a turbine unit, improve the flow to the second component and/or reduce or prevent critical excitations of a downstream rotor by appropriate choice of the total number of support ribs and flow splitter blades.

In one preferred embodiment, the transition channel is not annular, but has a radially inner and/or outer nonround envelope surface. This makes provision for the more thickly engineered support ribs in the oncoming flow direction, according to the rule of surfaces, by locally enlarging the envelope surface in the area of their connection to it.

### BRIEF DESCRIPTION OF THE DRAWINGS

Further advantages, features and details of the invention will emerge from the following description of a sample embodiment and also by means of the drawings, in which the same or functionally identical elements are given the same reference numbers. There are shown, partly schematized:

FIG. 1 is an axial section view (top) and a partial developed view (bottom) of a transition channel according to one sample embodiment of the present invention; and

FIG. 2 is a developed view corresponding to the lower region in FIG. 1 of a transition channel in a modification of the present invention.

### DETAILED DESCRIPTION

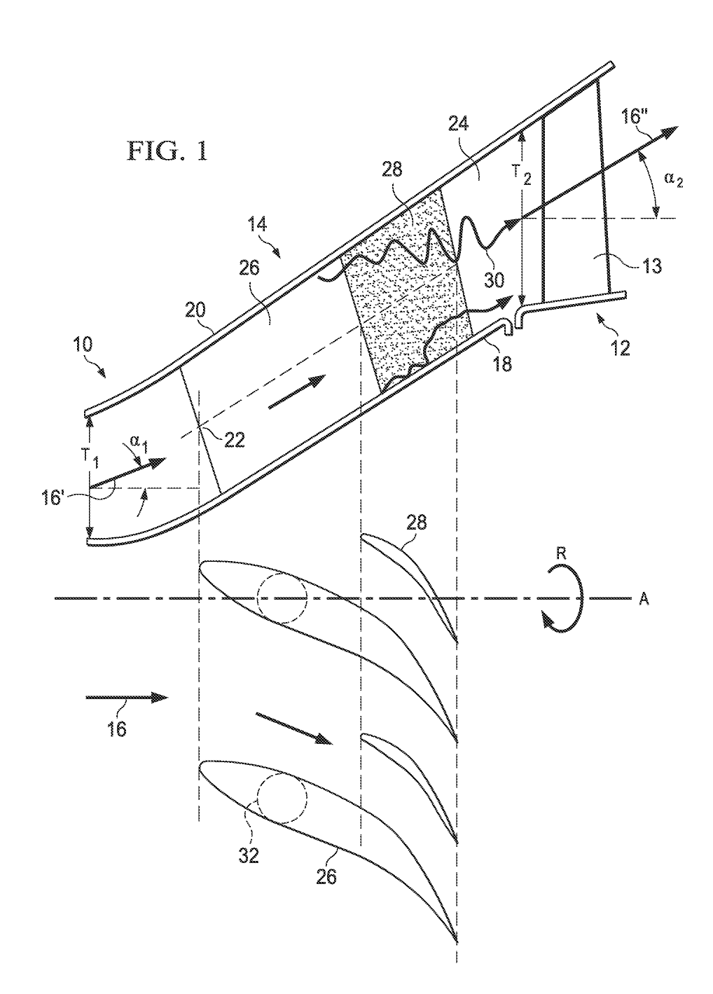

FIG. 1 shows, as an example, a transition channel between two components of a turbine, hereinafter turbine components, in axial half-section and median section (top part of the drawing) and in a planar developed view or profile section (bottom part of the drawing).

According to the representation in FIG. 1, a flow process between a high-pressure turbine 10 and a low-pressure turbine 12 is determined by a transition channel 14. The flow process is indicated by an arrow 16.

The transition channel 14 has an inner wall or envelope surface 18 and an outer wall or envelope surface 20, which together define an annular cross section. In particular, an entry cross section 22 is defined at the start of the transition channel 14 and an exit cross section 24 at the outlet of the transition channel 14. It should be noted that the transition channel 14 is configured stationary with respect to the turbine axis A or an otherwise not represented turbine housing, while the high-pressure turbine 10 and the low-pressure turbine 12 have rotors with rotating blades that turn in a direction of rotation R about the turbine axis A. In the figure, one rotating blade 13 of a first stage of the low-pressure turbine 12 is indicated.

As can be seen from the figure, the entry cross section 22 of the transition channel 14 is situated on the whole at a closer radial position to the turbine axis A than the exit cross section 24. Thus, the flow 16 is deflected radially outward from the entry cross section 22 to the exit cross section 24. Although a height (spacing between inner wall 18 and outer wall 20) of the transition channel 14 remains at least essentially constant, without limiting the generality, the cross section of the transition channel 14 recedes from the entry cross section 22 to the exit cross section 24, since a circumferential length of the exit cross section 24 is greater than a circumferential length of the entry cross section 22.

Between the inner wall 18 and the outer wall 20, which form envelope surfaces of the transition channel 14, several support ribs 26 extend distributed about the circumference of the transition channel 14. The support ribs 26 have a comparatively large relative thickness in order to fulfill their support effect and to be able to accommodate supply lines 32. Furthermore, the support ribs 26 have a winglike profile, which deflects the flow 16 in the circumferential direction.

In a rear downstream region of the transition channel 14 there are arranged flow splitter blades or vanes 28 between the support ribs 26. The splitter vanes 28 bring about a flow splitting between the support ribs 26 and help to deflect the flow 16 in the circumferential direction. The splitter vanes 28 are shorter than the support ribs 26 and have a wing profile, which is clearly more slender than the profile of the support ribs.

Referring still to FIG. 1, as indicated in the upper part of the figure, three-dimensional parasite secondary flows 30 can form in the axially rear (downstream) region of the transition channel. These secondary flows are induced by the twofold deflecting direction, namely, a deflection radially outward on the one hand and a circumferential deflection to achieve an optimal flow against the first rotor blade series 13 of the low-pressure turbine 12 on the other hand, as well as the complex velocity profile of the flow 16. These secondary flows 30 can lead to an unfavorable flow onto the following rotor blades 13 of the low-pressure turbine, a greater loading of the structural parts, and an excitation of the rotor blades and contribute to turbine noise. Thanks to the arrangement of the slender splitter vanes 28 between the thicker support ribs 26, the production of the parasite secondary flows 30 can be substantially reduced.

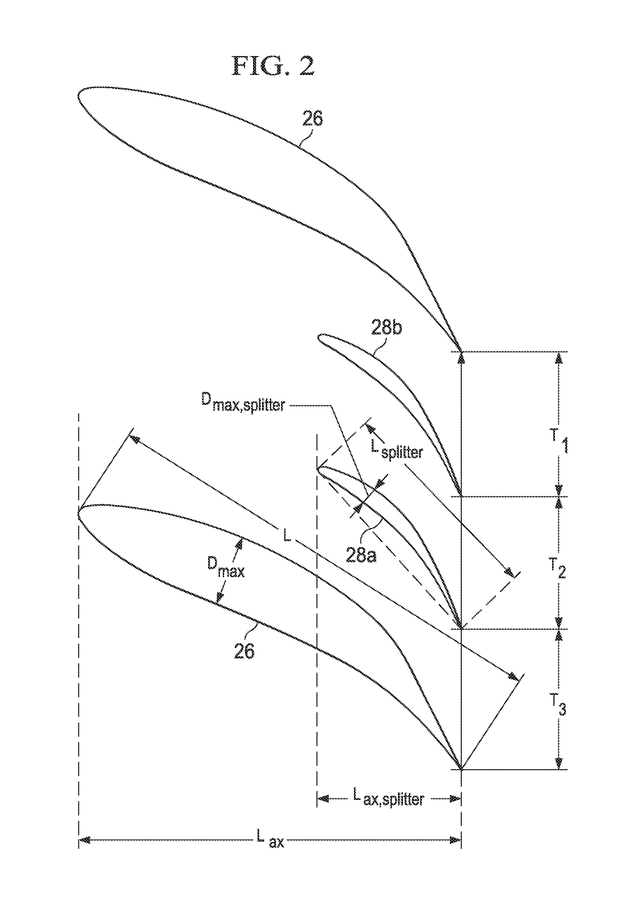

Referring now to FIG. 2, a modification of the layout of FIG. 1 is shown schematically in FIG. 2. According to the representation in FIG. 2, not one but two splitter vanes 28a, 28b are arranged between two support ribs 26. The aim is to have the splitter vanes 28 (28a, 28b) take over as much of the flow deflection as possible. The number of the long and heavy support ribs 26 is essentially determined by the stability requirements and the number or cross section size of the supply lines (32 in FIG. 1) to be accommodated in the support ribs 26.

In other modifications, the number of splitter vanes 28 between two support ribs 26 can be up to five or even more, if so desired.

Geometrical sizes of the support ribs 26 and the splitter vanes 28a, 28b are indicated in FIG. 2. An axial design depth of the support ribs 26 is indicated by Lₐₓ, a profile chord length by L, and a maximum profile thickness by Dₘₐₓ. The corresponding nomenclature for the splitter vanes are rendered by the additional subscript “Splitter”. An axial length or design depth of the transition channel 14 itself can be indicated by L_{ax, TMTF}. The axial design depth L_{ax, TMTF} of the transition channel 14 can coincide with or be defined by the axial length or design depth Lₐₓ of the support ribs 26.

In summary, features of the present invention that can be combined with each other can be indicated as follows:
a) deflecting support ribs 26 and thin splitter vanes 28 are arranged in tandem fashion in the transition channel 14;
b) the relative thickness d_{max, Splitter}/L of the splitter vanes 28 nowhere exceeds a limit value

d_{max, Splitter}/L<15%; in particular, d_{max, Splitter}/L<10%;
c) the axial design depth of the splitter vanes 28 is

25%<L_{ax, Splitter}/L_{ax, TMTF}; in particular, 30%<L_{ax, Splitter}/L_{ax, TMTF}, and/or

L_{ax, Splitter}/L_{ax, TMTF}<100%;
d) the splitter vanes 28 extend in a region which begins the earliest at 30% L_{ax, TMTF} in the axial direction, i.e., it is set back from the front edges of the support ribs 26 in the flow direction, and ends at no more than 125% of L_{ax, TMTF,} i.e., the splitter vanes 28 can project back behind rear edges of the support ribs 26 in the flow direction.

It has shown itself to be advantageous for the axial surface ratio F2/F1 to be between 2 and 5 (2≦F2/F1≦5) and/or for the deflection angle Δα=α1−α2 to be less than 50°. The entry surface F1 and the exit surface F2 here stand perpendicular to the turbine axis A. As can be seen from FIG. 1, the surfaces F1 and F2 are shown at one end and at the other end of the transition channel 14. The entry flow 16′ starting at the turbine axis A is tilted by the entry flow angle α1 and reflects the entry flow into the transition channel 14. The exit flow 16″ starting at the turbine axis A is tilted by the exit flow angle α2 and reflects the exit flow from the transition channel 14. The two flow angles α1 and α2 result from the mass-averaged axial and circumferential velocities c_{Axial} and c_{Umfang} in the planes F1 and F2, per α=arctan (c_{Axial}/c_{Umfang}).

Moreover, it has proven to be advantageous, in the case of a splitter vane 28, for the partitions T1 and T2 to be different, and for several splitter vanes 28a, etc., for the partitions T1 to Tn (for n−1 splitter blades) to be different. The splitter chord lengths Lₛₚₗᵢₜₜₑᵣ can then also be different.

In the representation of FIG. 1, a high-pressure turbine 10 and a low-pressure turbine 12 are only indicated quite schematically. This can involve a high-speed low-pressure turbine when a gear fan is present. Of course, the high-pressure turbine 10 and the low-pressure turbine 12 can be constructed from one or more stages of rotor blade and guide vane series.

The present invention also finds application in a three-piece turbine layout with a high-pressure turbine, a medium-pressure turbine and a low-pressure turbine. The transition channel of the invention is preferably arranged between the medium-pressure turbine and the low-pressure turbine. However, the transition channel of the invention can also be arranged between the high-pressure turbine and the medium-pressure turbine.

The high-pressure turbine 10 and the low-pressure turbine 12 are examples of turbine components in the sense of the present invention. The splitter vanes 28 are flow partitioning blades in the sense of the present invention. The arrangement shown in FIG. 1 of a high-pressure turbine, the transition channel 14, and the low-pressure turbine 12 is part of a turbine unit in the sense of the present invention.

The present invention is especially applicable to turbine units that are part of a jet engine, especially an aircraft engine.

### LIST OF REFERENCE NUMBERS

10 high-pressure turbine
12 low-pressure turbine
13 rotor (blade)
14 transition channel
16′ entry flow
16″ exit flow
18 inner wall
20 outer wall
22 entry cross section
24 exit cross section
26 support ribs
28 flow splitter blades (vanes)
30 secondary flow
32 supply line
dₘₐₓ largest profile thickness of the support ribs
d_{max, Splitter} largest profile thickness of the splitter vanes
A turbine axis
F1 entry surface at start of the transition channel
F2 exit surface at end of the transition channel
L profile chord length
L_{Splitter} profile chord length of the splitter vanes
Lₐₓ axial design depth of the support ribs
L_{ax, Splitter} axial design depth of the splitter vanes
L_{ax, TMTF} axial design depth of the transition channel
R direction of rotation
T1 to Tn partitioning (distance (running perpendicular to the turbine axis) between the exit edges of the support ribs and the splitter vanes
   The above list of reference symbols is an integral part of the specification.

What is claimed is:

1. A transition channel for a turbine unit having a turbine axis and a flow direction and at least a first component of a higher pressure and a second component of a lower pressure, the transition channel comprising:
an inner envelope surface disposed around the turbine axis and an outer envelope surface disposed around the inner envelope surface so as to define a flow channel therebetween, the flow channel extending axially between an inlet cross section of the transition channel disposed proximate to one of the first and second components and an outlet cross section of the transition channel disposed proximate to the other of the first and second components;
at least two support ribs extending between the inner and outer envelope surfaces of the transition channel and being circumferentially spaced apart from one another, each support rib having a profile that is configured for deflecting a flow from the inlet cross section to the outlet cross section; and
a plurality of flow splitter blades disposed circumferentially between the support ribs, the relative profile thickness of the flow splitter blades being smaller than the relative profile thickness of the support ribs.

2. A transition channel in accordance with claim 1, wherein the relative profile thickness of at least one flow splitter blade is not greater than 10%.

3. A transition channel in accordance with claim 2, wherein the relative profile thickness of at least one flow splitter blade is not greater than 20%.

4. A transition channel in accordance with claim 1, wherein the front edges of at least some of the flow splitter blades are positioned in the axial direction to the rear of the front edges of the support ribs.

5. A transition channel in accordance with claim 4, wherein a front edge of at least one flow splitter blade is distant in the axial direction from a front edge of a support rib by at least 30% of an axial design depth of the support rib.

6. A transition channel in accordance with claim 1, wherein a rear edge of a flow splitter blade projects beyond a rear edge of the support rib in the axial direction by up to 25% of an axial design depth of a support rib.

7. A transition channel in accordance with claim 1, wherein an axial design depth of a flow splitter blade is less than the axial design depth of a support rib but at least 30% of the axial design depth of the support rib.

8. A transition channel in accordance with claim 1, wherein precisely one flow splitter blade is disposed between each two support ribs in the circumferential direction.

9. A transition channel in accordance with claim 1, wherein from two to five flow splitter blades are arranged between every two support ribs in the circumferential direction.

10. A transition channel in accordance with claim 1, wherein at least one of a flow splitter blade and a support rib has a wing profile.

11. A transition channel in accordance with claim 1, wherein further at least:
an axial design depth of the flow splitter blades is shorter than an axial design depth of the support ribs but at least 30% of the axial design depth of the support ribs; or
a profile chord length of the flow splitter blades is shorter than a profile chord length of the support ribs but at least 30% of the profile chord length of the support ribs.

12. A transition channel in accordance with claim 1, wherein one of:
the first component is a high-pressure turbine and the second component is a low-pressure turbine and the flow direction is from the first component to the second component;
the first component is a high-pressure turbine and the second component is a medium-pressure turbine and the flow direction is from the first component to the second component;
the first component is a medium-pressure turbine and the second component is a low-pressure turbine and the flow direction is from the first component to the second component; or
the first component is a second stage of a compressor and the second component is a first stage of a compressor and the flow direction is from the second component to the first component.

13. A transition channel in accordance with claim 1, wherein the flow channel has an annular cross section radially receding from the turbine axis in the flow direction.

14. A transition channel in accordance with claim 1, wherein the transition channel in the region of a support rib has a larger radial dimension than in the region of a flow splitter blade.

15. A turbine unit having a turbine axis and a direction of flow, the turbine unit comprising:
a first component disposed along the turbine axis and having an exit cross section;
a second component disposed along the turbine axis and having an entry cross section;
the first component being associated with a higher pressure than the second component;
the exit cross section of the first component having a smaller radial spacing than the entry cross section of the second component;
a transition channel disposed between the first component and the second component and defining a flow channel between the exit cross section of the first component and the entry cross section of the second component, the transition channel including
an inner envelope surface disposed around the turbine axis and an outer envelope surface disposed around the inner envelope surface so as to define a flow channel therebetween extending axially between an inlet cross section of the transition channel that is disposed proximate to the exit cross section of the first component and an outlet cross section of the transition channel that is disposed proximate to the entry cross section of the second component,
at least two support ribs extending between the inner and outer envelope surfaces of the transition channel and being circumferentially spaced apart from one another, each support rib having a profile that is configured for deflecting a flow from the inlet cross section to the outlet cross section, and
a plurality of flow splitter blades disposed circumferentially between the support ribs; and
wherein at least one of
the relative profile thickness of the flow splitter blades is smaller than the relative profile thickness of the support ribs;
an axial design depth of the flow splitter blades is shorter than an axial design depth of the support ribs but at least 30% of the axial design depth of the support ribs; or
a profile chord length of the flow splitter blades is shorter than a profile chord length of the support ribs but at least 30% of the profile chord length of the support ribs.

16. A turbine unit in accordance with claim 15, wherein the front edge of a flow splitter blade is distant in the axial direction from a front edge of a support rib by at least 30% of an axial design depth of the support rib.

17. A turbine unit in accordance with claim 15, wherein a rear edge of a flow splitter blade projects beyond a rear edge of the support rib in the axial direction by up to 25% of an axial design depth of a support rib.

18. A jet engine including a compressor unit, a turbine unit, a turbine axis and a direction of flow, one of the turbine unit and the compressor unit further including a first component and a second component, the jet engine comprising:
a first component disposed along the turbine axis and having an exit cross section;
a second component disposed along the turbine axis and having an entry cross section;
the first component being associated with a different pressure than the second component;
the exit cross section of the first component having a different radial spacing than the entry cross section of the second component;
a transition channel disposed between the first component and the second component and defining a flow channel between the exit cross section of the first component and the entry cross section of the second component, the transition channel including
an inner envelope surface disposed around the turbine axis and an outer envelope surface disposed around the inner envelope surface so as to define a flow channel therebetween extending axially between an inlet cross section of the transition channel that is disposed proximate to the exit cross section of the first component and an outlet cross section of the transition channel that is disposed proximate to the entry cross section of the second component,
at least two support ribs extending between the inner and outer envelope surfaces of the transition channel and being circumferentially spaced apart from one another, each support rib having a profile that is configured for deflecting a flow from the inlet cross section to the outlet cross section, and
a plurality of flow splitter blades disposed circumferentially between the support ribs; and
wherein at least one of
the relative profile thickness of the flow splitter blades is smaller than the relative profile thickness of the support ribs;
an axial design depth of the flow splitter blades is shorter than an axial design depth of the support ribs but at least 30% of the axial design depth of the support ribs; or
a profile chord length of the flow splitter blades is shorter than a profile chord length of the support ribs but at least 30% of the profile chord length of the support ribs.

19. A jet engine in accordance with claim 18, wherein the front edge of a flow splitter blade is distant in the axial direction from a front edge of a support rib by at least 30% of an axial design depth of the support rib.

20. A turbine unit in accordance with claim 19, wherein a rear edge of a flow splitter blade projects beyond a rear edge of the support rib in the axial direction by up to 25% of an axial design depth of a support rib.
